(19) United States
(12) Patent Application Publication
(10) Pub. No.: US 2002/0005619 A1
(43) Pub. Date: Jan. 17, 2002

(54) Wheelbarrow braking system

(76) Inventor: Gary P. Cote, Fitchburg, MA (US)

Correspondence Address: James C. Wray, Suite 300, 1493 Chain Bridge Road, McLean, VA, 22101, US

(21) Appl. No.: 09/899,029

(22) Filed: Jul. 6, 2001

Related U.S. Application Data
(60) Provisional application No. 60/216,673, filed on Jul. 7, 2000.

(51) Int. Cl. B62B 1/18; B62B 5/04

(52) U.S. Cl. 280/47.31; 188/19; 188/9

(57) ABSTRACT

A wheelbarrow braking system helps control speed of a wheelbarrow on a slope. A braking mechanism, such as a drum brake, a disc brake assembly or a caliper brake for the wheel, has a control cable and a twist-type control handle, which is installed in place of one of the regular handle grips. A simple twist of the handle operates the brake cable to activate the braking mechanism. A brake drum is mounted on one side of the single wheel by either bolting or welding the brake drum mounting plate to the rim of the wheel. For a two-wheeled wheelbarrow, a brake drum is mounted in the center of the axle upon which the two wheels are supported. Simply twisting the handle activates the braking system. This allows the operator to maintain contact with both handle bars during braking, facilitating greater control of the wheelbarrow. Caliper brakes may be used in the wheelbarrow braking system. A frame mounted caliper presses against a disc mounted on the wheel of the wheelbarrow to slow the wheelbarrow by friction.

### BACKGROUND OF THE INVENTION

This application claims the benefit of U.S. Provisional Application No. 60/216,673 filed Jul. 7, 2000.

The wheelbarrow has been and continues to be widely used to facilitate the moving of heavy objects. One problem with the conventional wheelbarrow actually relates to its inclusion of a wheel. While the wheel is essential to the easy use of the device, it can present problems in handling, especially on slopes. When a person is trying to move a load in a wheelbarrow down a hill, the force of gravity pulls the wheelbarrow and increases its speed. The user must exert a lot of effort to keep the wheelbarrow in check; otherwise, he may end up running along with it, or he may allow it to escape his grasp and roll away alone.

To solve this problem, devices have been developed to provide braking for wheelbarrows, allowing the operator greater control over the apparatus. Conventional braking systems for wheelbarrows include a wheelbarrow equipped with a squeezable brake lever on one or both handles, a wheelbarrow with a hand-grip brake in which the hand grip slides from front-to-back relative to the handlebar, and a three-wheeled wheelbarrow with brakes on its back wheels.

Needs exist for a wheelbarrow braking system in which an operator may easily control the speed of the wheelbarrow while maintaining contact with both handlebars.

### SUMMARY OF THE INVENTION

The wheelbarrow braking system of the present invention helps a person control the speed of a wheelbarrow on a slope. The present invention comprises a brake kit for a wheelbarrow, including a braking mechanism such as, but not limited to, a drum brake, a disc brake assembly or a caliper brake for the wheel, a control cable, and a motorcycle “twist-type” control handle, which is installed in place of one of the regular handle grips. A simple twist of the handle operates the brake cable to activate the braking mechanism. In addition to being added to new wheelbarrows during manufacture, the braking system of the present invention may be retrofit onto existing wheelbarrows. The design of the braking system may be tailored to suit heavyor light-duty wheelbarrows for all manner of applications.

The main benefit of the wheelbarrow braking system described herein is the added control it provides for a wheelbarrow user. The braking system is easy to add to either a new or existing wheelbarrow, and once installed, it provides a way to slow or stop the wheelbarrow. By applying the brake slightly, a user can control the speed of the wheelbarrow on a hill. In this way, he may prevent the wheelbarrow from picking up speed and escaping his grasp. The user may stop the wheelbarrow safely while on a hill simply by turning the brake control to its fullest extent. Using the brake is much easier than holding back the wheelbarrow physically. With a load of heavy material in it, a wheelbarrow may be quite difficult for a person to push or pull, especially on a hill. It may take all the person's strength and most of the muscles of his body to move or restrain the load. With this braking system, though, slowing or stopping a rolling wheelbarrow only requires the turning power of a single hand, thus saving a lot of physical exertion and possibly preventing muscle strains or similar injuries.

This wheelbarrow braking system is similar in both design and construction to braking systems currently used for the rear brakes of automobiles and motorcycles. The system includes a braking mechanism. A preferred embodiment of the braking system comprises a pair of spring-loaded brake shoes mounted inside a steel drum assembly. A plastic drum with a steel liner may be substituted for an all-steel brake drum for a lighter-duty version of this embodiment of the wheelbarrow braking system. The drum brakes of a preferred embodiment are totally enclosed and sealed within a brake drum for safety and to keep external debris from interfering with the components of the brake. The braking mechanism of the wheelbarrow braking system is not limited to a drum brake.

For a single-wheeled wheelbarrow, a preferred embodiment of the braking mechanism comprises a spring loaded brake drum with brake shoes, or a caliper with a disc on either side of the rim. For a heavier-duty, two-wheeled wheelbarrow, a preferred embodiment of the braking system comprises a brake drum mounted in the center of the axle upon which the two wheels are supported. In both cases, the braking mechanism is connected to the control handle for the brakes via a steel brake cable. This control handle, in essence a twist-type motorcycle handle is conveniently mounted at the end of a handle bar. Simply twisting the handle activates the braking system. This allows the operator to maintain contact with both handle bars during braking, facilitating greater control of the wheelbarrow.

Caliper brakes may be used in the wheelbarrow braking system of the present invention. The caliper brakes press a brake pad against a fixed disc of the wheelbarrow to slow the wheelbarrow by friction. The caliper brakes are supported on a brace—which spans the tire of the wheelbarrow, allowing the caliper brakes to act on both sides of the tire. A brake cable controls the engaging of the caliper brakes. The brake cable connects a twist-type handle to the caliper brakes. A slight twist of the handle results in a slowing of the wheelbarrow, while a quarter turn of the handle will stop the wheelbarrow completely. The amount of force exerted upon the handle is directly related to the degree of pressure exerted by the braking mechanism such as, but not limited to, a caliper brake. Once twisted a quarter turn the twist-type handle may be locked into position using a clipping means. This serves as a parking brake for the stopped wheelbarrow. The brake cable may terminate in a large pitch screw which moves freely in both directions or which requires force to move in either direction or preferably which is spring loaded in the brake releasing direction.

A preferred embodiment of the wheelbarrow braking system of the present invention incorporates a drum braking mechanism comprising a frame mounted caliper which presses against a disc mounted on the wheel of the wheelbarrow to slow the wheelbarrow by friction. A brake cable controls the engaging of the frame mounted caliper. The brake cable is connected to a twist-type handle. A slight twist of the handle results in a slowing of the wheelbarrow, while a quarter turn of the handle will stop the wheelbarrow completely. The amount of force exerted upon the handle is directly related to the degree of pressure exerted by a braking mechanism such as, but not limited to, a drum brake assembly. Once twisted a quarter turn, the twist-type handle may be locked into position using a clipping means. This serves as a parking brake for the stopped wheelbarrow.

These and further and other objects and features of the invention are apparent in the disclosure, which includes the above and ongoing written specification, with the claims and the drawings.

### BRIEF DESCRIPTION OF DRAWINGS

FIG. 1 is a perspective view of a single-wheeled wheelbarrow equipped with a preferred embodiment of the wheelbarrow braking system of the present invention.

FIG. 2 is a perspective view of a twist-type handle and a brake cable mounted on a wheelbarrow handlebar.

FIG. 3 is side view of a wheel of a wheelbarrow equipped with a preferred embodiment of the wheelbarrow braking system of the present invention with a drum brake as the braking mechanism.

FIG. 4 is a perspective view of a two-wheeled wheelbarrow equipped with a preferred embodiment of the wheelbarrow braking system of the present invention.

FIG. 5 is a sectional side view of a two-wheeled wheelbarrow equipped with a preferred embodiment of the wheelbarrow braking system of the present invention.

FIG. 6 is a front view of a two-wheeled wheelbarrow equipped with a preferred embodiment of the wheelbarrow braking system of the present invention.

FIG. 7 is a detail of brake shoes and a backing plate.

FIG. 8 is a side view of a wheel of a wheelbarrow equipped with a preferred embodiment of the wheelbarrow braking system of the present invention with a frame mounted caliper with wheel brake assembly as the braking mechanism.

### DETAILED DESCRIPTION OF PREFERRED EMBODIMENTS

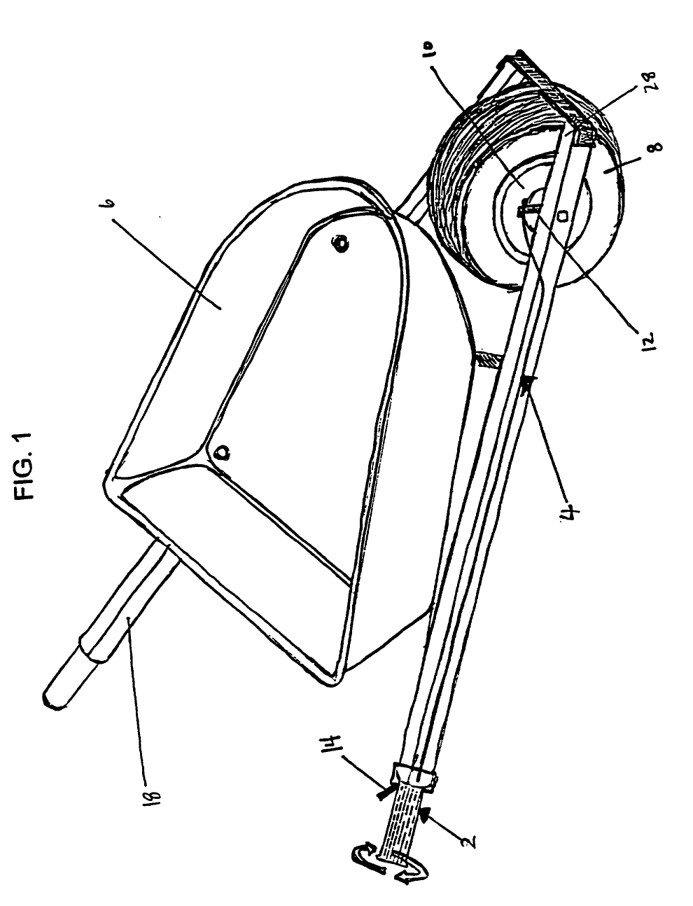

As shown in FIGS. 1-3, the wheelbarrow braking system of the present invention comprises a braking mechanism such as, but not limited to, a drum brake 10, a brake cable 4 and a twist-type handle 2. The braking system may be installed on a new wheelbarrow 30 at the time of manufacture, or may be installed on an existing wheelbarrow 30. The wheelbarrow 30 comprises a box 6 from which handlebars extend 18 to M and steer the wheelbarrow 30. The box 6 is mounted on a frame 28, which extends forward and supports a wheel 8. The twist-type handle 2 is installed on one handlebar 18 of the wheelbarrow 30. The twist-type handle 2 is connected to a brake cable 4, for controlling a braking mechanism such as, but not limited to, a drum brake 10. A brake arm 12 connects the brake cable 4 to the 10.

To operate the braking system, an operator twists the twist-type handle 2 to engage the braking mechanism such as, but not limited to, a drum brake 10, a frame mounted caliper 40 with wheel disc assembly 42. A slight twist results in a slowing of the wheelbarrow 30, while a quarter turn of the handle 2 will stop the wheelbarrow 30 completely. The amount of force exerted upon the handle 2 is directly related to the degree of pressure the drum brake 10 exerts. Once twisted a quarter turn, the twist-type handle 2 may be locked into position using a clipping means 14. This serves as a parking brake for the stopped wheelbarrow 30. The brake cable 4 may terminate in a large pitch ball bearing screw which moves freely in both directions or which requires force to move in either direction or preferably which is spring loaded in the brake releasing direction.

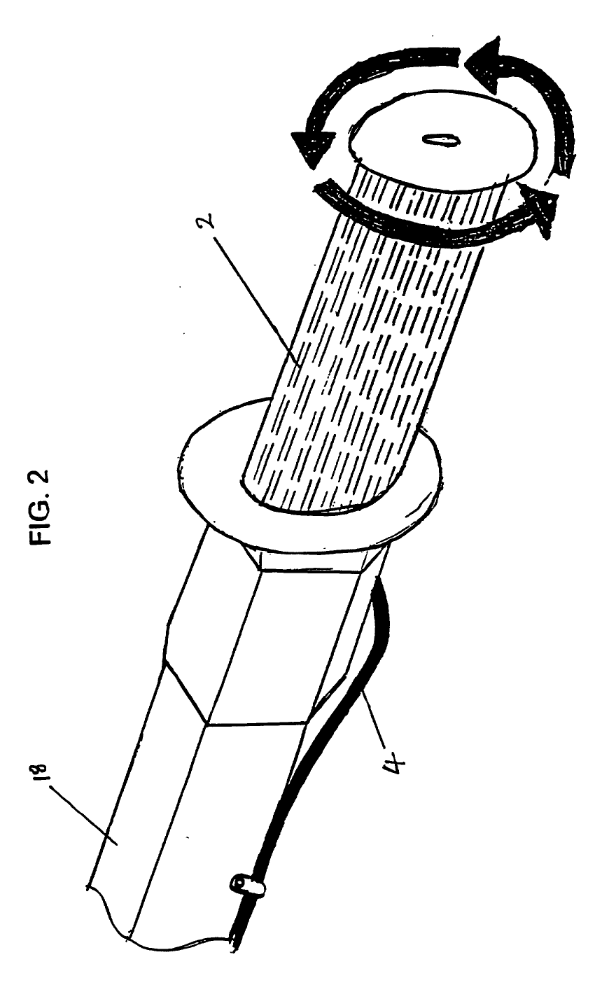

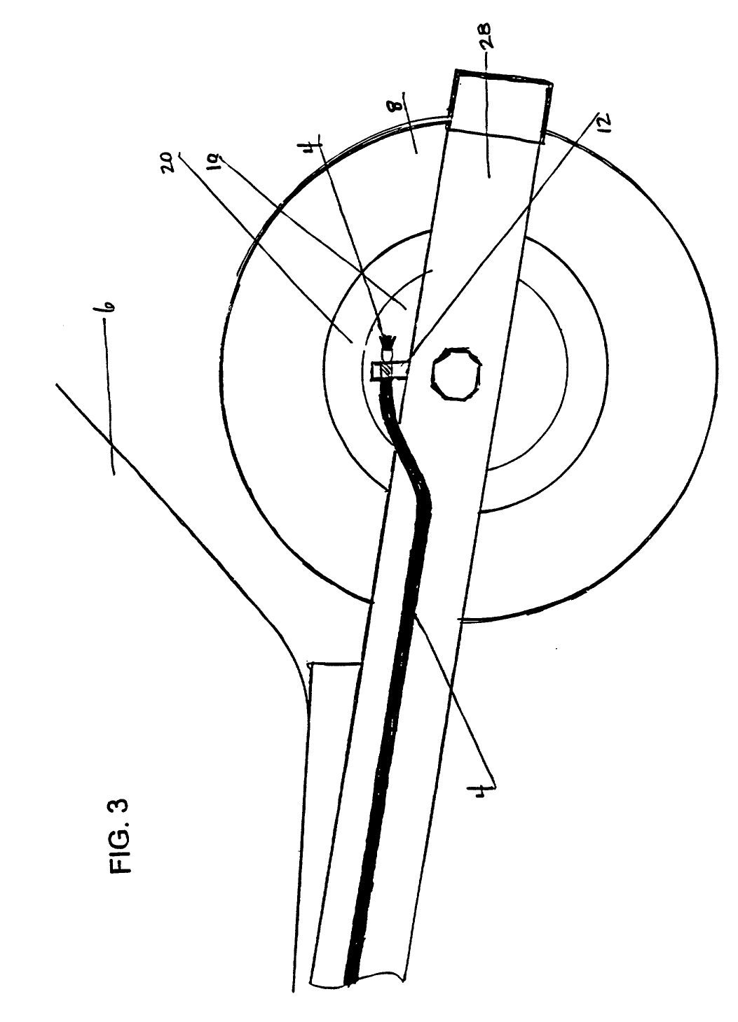

FIG. 3 is a detail view of the wheelbarrow shown in FIGS. 1 and 2. The wheelbarrow is equipped with the wheelbarrow braking system of the present invention showing a brake cable 4 mounted on the inside of a wheelbarrow frame 28. The brake cable 4 is positioned to connect to the braking mechanism such as, but not limited to, a drum brake 10 by a brake arm connector 12. In a preferred embodiment, an internal drum brake 10 is mounted onto a fixed rim 20 of a standard wheelbarrow wheel 8.

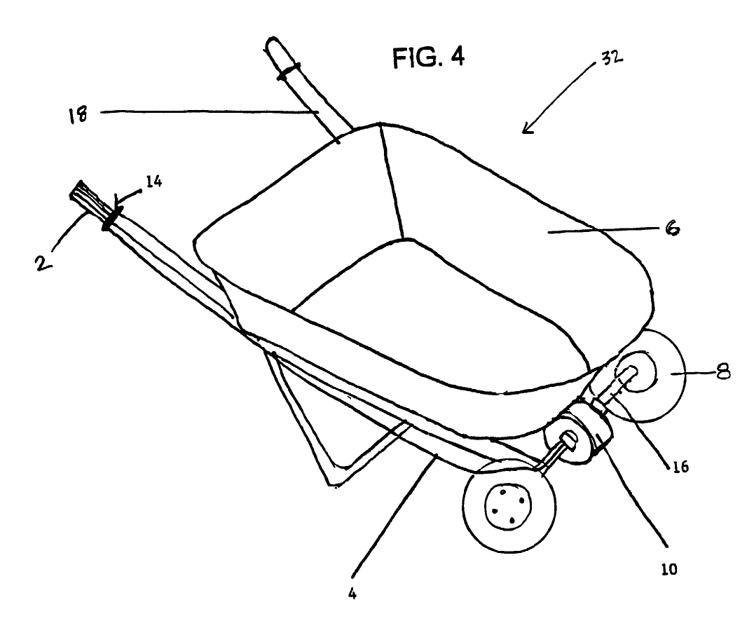

The wheelbarrow braking system may also integrated into heavier-duty two-wheeled wheelbarrows 32 as shown in FIGS. 4-7. FIG. 4 is a schematic representation of a two-wheeled wheelbarrow 32 comprising a box 6 from which project handlebars 18 for lifting and steering the wheelbarrow 32. The two wheels 8 of the wheelbarrow 32 are supported on an axle 16. The braking system for a two-wheeled wheelbarrow 32 has the same components as the braking system for a single-wheeled wheelbarrow 30: a twist-type handle 2, a brake cable 4, and a braking mechanism such as, but not limited to, a drum brake 10, a frame mounted caliper 40 with wheel disc assembly 42. In a preferred embodiment, a drum brake 10 is mounted in the center of the axle 16 upon which the two wheels 8 are supported. In this way, the braking mechanism such as, but not limited to, a drum brake 10 can simultaneously control the rotation of both wheels 8. For clarity, the brackets and bearings which support the axle have been omitted from the drawings. The brake cable 4 connects the braking mechanism such as, but not limited to a drum brake 10 to the twist-type handle 2. The operator controls the speed of the wheelbarrow 32 by twisting the handle 2. A slight twist slows the wheelbarrow 32, and a quarter turn of the handle 2 stops the wheelbarrow 32. The degree of force exerted upon the handle 2 is directly related to the degree of pressure exerted by the braking mechanism such as, but not limited to, a drum brake 10. Once turned a quarter turn, the handle 2 may be locked into position using a clipping means 14. This serves as a parking brake for the stopped wheelbarrow 32.

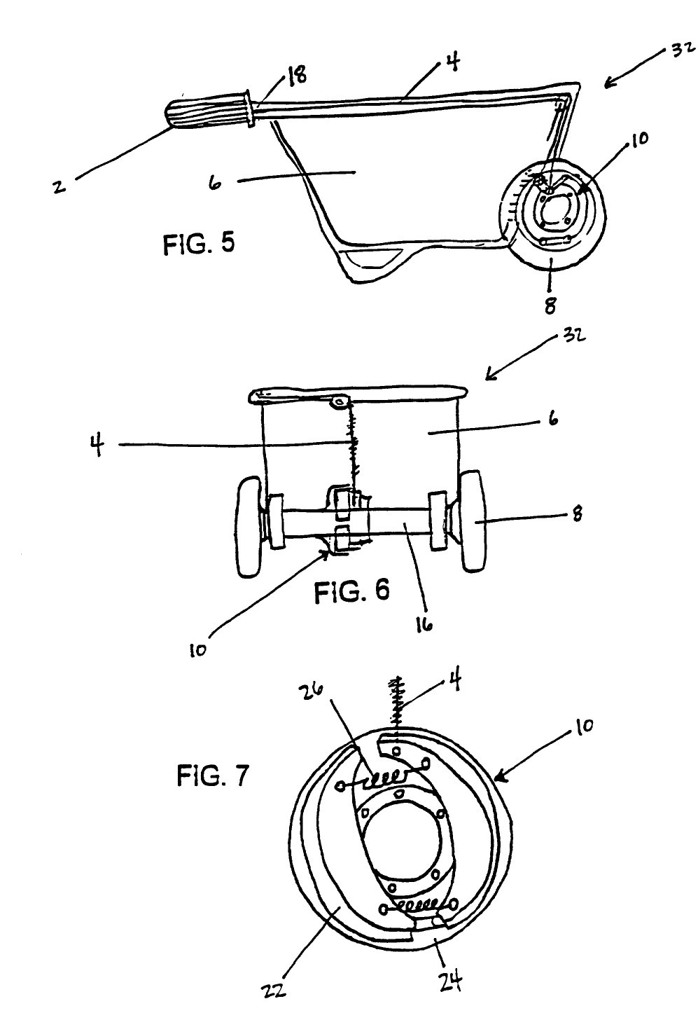

FIGS. 5 and 6 show a two-wheeled wheelbarrow 32 equipped with a preferred embodiment of the wheelbarrow braking system of the present invention; FIG. 5 is a cross-sectional side view of the wheelbarrow 32, and FIG. 6 is a front view of the wheelbarrow 32. The wheelbarrow 32 comprises a barrow 6 from which extend handlebars 18 for steering the barrow 6. A twist-type handle 2 is mounted on the end of one of the handlebars 18. A brake cable 4 attaches to the twist-type handle 2, connecting the handle 2 and a braking mechanism such as, but not limited to, a drum brake 10. In a preferred embodiment, a drum brake 10 is mounted in the center of the axle 16 upon which the wheels 8 of the wheelbarrow 32 are supported. The brake drum 10 of the preferred embodiment is bolted or welded to the axle 16 and the brake housing which hold the brake shoes 22 is supported on the frame 28 at the front of the box 6.

As shown in FIG. 7, a preferred embodiment of the braking mechanism comprises a drum brake 10 comprising brake shoes 22, which are spring-loaded 26, mounted on a backing plate 24. The brake cable 4 controls the engaging of the drum brake 10.

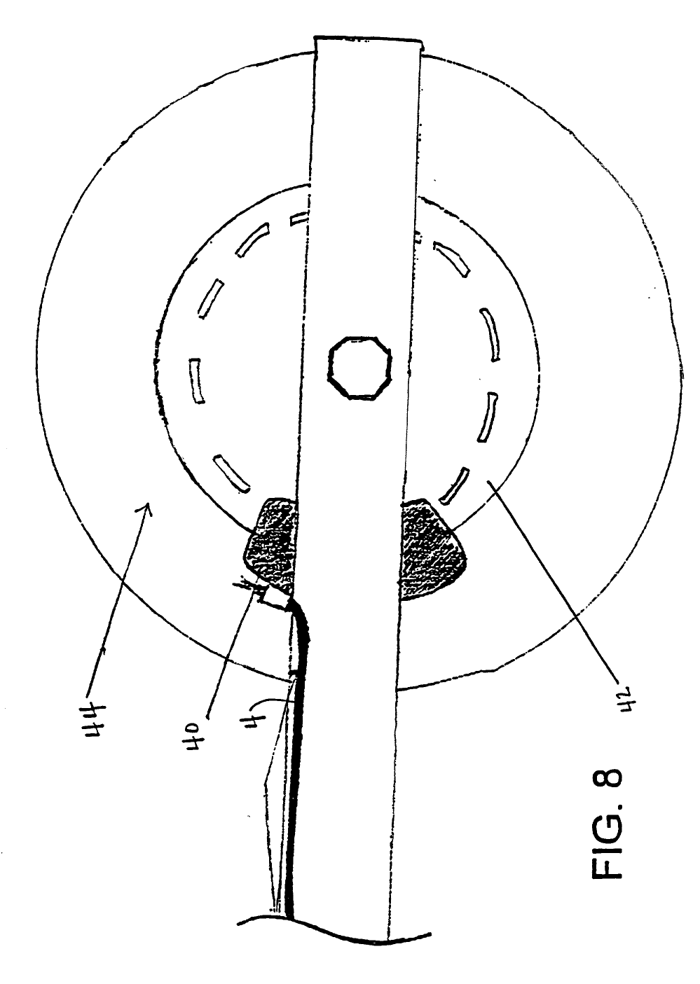

FIG. 8 shows a preferred embodiment of the wheelbarrow braking system of the present invention in which the braking mechanism is a disc assembly brake 42 comprising a frame mounted caliper 40 which presses against a disc 44 mounted on the wheel 8 of the wheelbarrow 30 to slow the wheelbarrow 30 by friction. A brake cable 4 controls the engaging of the frame mounted caliper 40. The brake cable 4 is connected to a twist-type handle 2. A slight twist of the handle 2 results in a slowing of the wheelbarrow 30, while a quarter turn of the handle 2 will stop the wheelbarrow 30 completely. The amount of force exerted upon the handle 2 is directly related to the degree of pressure the braking mechanism such as, but not limited to, a disc brake assembly 44, exerts. Once twisted a quarter turn, the twist-type handle may be locked into position using a clipping means 14. This serves as a parking brake for the stopped wheelbarrow 30.

While this invention has been described with reference to specific embodiments, modifications and variations of the invention may be constructed without departing from the scope of the invention, which is defined in the following claims.

I claim:

1. Wheelbarrow braking system for controlling speed of a wheelbarrow comprising a braking mechanism for a wheelbarrow with handle bars and a wheel comprising a drum brake, a brake assembly for the wheel, a control handle, a control cable coupling the brake assembly and the control handle for activating the braking mechanism and controlling movement of the wheelbarrow.

2. The system of claim 1, wherein the braking mechanism comprises a drum assembly and a pair of spring-loaded brake shoes mounted inside the drum assembly.

3. The system of claim 2, wherein the drum assembly is a steel drum assembly.

4. The system of claim 2, wherein the drum assembly comprises a plastic drum with a steel liner.

5. The system of claim 2, wherein the drum assembly further comprises a drum and an enclosure for sealing and protecting the drum from external material.

6. The system of claim 5, further comprising a mounting plate for the drum and connectors for mounting the plate to a rim of the wheel.

7. The system of claim 6, wherein the connectors are bolt or weld connectors.

8. The system of claim 5, further comprising an axle supporting wheels of the wheelbarrow, wherein the drum is mounted centrally on the axle between the wheels.

9. The system of claim 1, wherein the control handle is a twist-type motorcycle handle mounted at an end of the handle bars of the wheelbarrow.

10. The system of claim 10, wherein the control handle twists to different degrees for activating the braking mechanism without losing contact with the handle bars of the wheelbarrow during braking.

11. The system of claim 10, wherein a slight twist of the handle slows the wheelbarrow.

12. The system of claim 10, wherein a quarter twist of the handle stops the wheelbarrow.

13. The system of claim 10, wherein an amount of force exerted upon the control handle is directly proportional to a degree of pressure exerted by the braking mechanism on the wheel of the wheelbarrow.

14. The system of claim 10, further comprising clipping means for locking the control handle at desired positions after twisting the handle.

15. The system of claim 14, wherein the clipping means forms a parking brake for the wheelbarrow by locking the control handle.

16. The system of claim 1, wherein the cable is a steel brake cable.

17. The system of claim 1, further comprising a large pitch screw on an end of the control cable, wherein the bearing screw is freely movable in opposite directions.

18. The system of claim 17, wherein the bearing screw is in is spring loaded in a brake releasing direction.

19. The system of claim 1, wherein the brake assembly comprises caliper brakes.

20. The system of claim 19, wherein the brake assembly further comprises a brake pad and wherein the caliper brakes act upon the brake pad for friction-controlling a movement of the wheelbarrow.

21. The system of claim 20, further comprising a brace spanning the wheel of the wheelbarrow, wherein the caliper brakes engage opposite sides of the wheel.

22. The system of claim 20, wherein the control cable controls engagement of the caliper brakes.

23. The system of claim 22, wherein the control handle is a twist-type handle, and wherein the control cable couples the twist-type handle to the caliper brakes.

24. The system of claim 1, wherein the braking mechanism comprises a disc brake.

25. The system of claim 24, wherein the disc brake comprises a frame mounted caliper, and a disc mounted on the wheel of the wheelbarrow, wherein the caliper acts upon the disc for slowing the wheelbarrow by friction.

26. The system of claim 25, wherein the control handle is a twist-type handle, and wherein the control cable connects the handle and the frame mounted caliper, thereby controlling engagement of the frame mounted caliper with the wheel.

27. The system of claim 1, wherein the wheelbarrow comprises two wheels and a box from which project the handlebars for lifting and steering the wheelbarrow.

28. The system of claim 27, further comprising an axle for supporting the two wheels of the wheelbarrow, and a drum brake mounted in a center of the axle for simultaneously controlling rotation of the two wheels.

29. The system of claim 1, wherein the wheelbarrow further comprises a frame, a box on the frame, wherein the handlebars extend from the box and the control handle is coupled to an end of the handlebars.

30. The system of claim 29, wherein the box has extensions for supporting the wheel, and wherein the control cable couples the control handle to the brake assembly for controlling a movement of the wheel.

31. Braking apparatus comprising a braking mechanism including a brake, a twist-type handle and a brake cable connecting the twist-type handle and the brake, wherein the handle is twistable to a plurality of positions for controlling speeds of movement of vehicles coupled to the braking mechanism.

32. The apparatus of claim 31, wherein a twist of the handle slows the vehicles.

33. The apparatus of claim 31, wherein a quarter turn of the handle stops the vehicles.

34. The apparatus of claim 31, wherein an amount of force exerted upon the handle is directly proportional to a degree of pressure exerted by the brake.

35. The apparatus of claim 31, further comprising a clipper for locking the handle at desired positions.

36. The apparatus of claim 35, wherein the clipper forms a parking brake.

37. The apparatus of claim 31, further comprising a pitch screw on an end of the cable movable freely in different directions.

38. The apparatus of claim 37, wherein the screw is spring loaded in a brake releasing direction.

39. The apparatus of claim 31, wherein the brake is a drum brake.

40. The apparatus of claim 39, further comprising a brake arm connecting the brake cable to the drum brake.

41. The apparatus of claim 40, further comprising an internal drum mounted on a fixed rim of a wheel.

42. The apparatus of claim 39, further comprising a backing plate for the drum brake and spring-loaded brake shoes mounted on the backing plate, wherein the brake cable controls engagement of the drum brake with the wheels.

43. The apparatus of claim 31, wherein the brake is a frame mounted caliper having a wheel disc assembly.

44. The apparatus of claim 43, further comprising a disc coupled to the wheel disc assembly for engaging the wheels and reducing movement speeds by friction.

45. The apparatus of claim 31, wherein the vehicles include a wheelbarrow.
